(19) United States
(12) Patent Application Publication
(10) Pub. No.: US 2008/0044774 A1
(43) Pub. Date: Feb. 21, 2008

(54) METHOD FOR EXPOSING TWICE BY TWO MASKS IN SEMICONDUCTOR PROCESS

(75) Inventors: Cheng-Hsueh SU, Kaohsiung (TW); Tsung-Chieh HO, Kaohsiung (TW)

Correspondence Address: VOLENTINE & WHITT PLLC, ONE FREEDOM SQUARE, 11951 FREEDOM DRIVE SUITE 1260, RESTON, VA, 20190, US

(73) Assignee: ADVANCED SEMICONDUCTOR ENGINEERING, INC., Kaohsiung (TW)

(21) Appl. No.: 11/835,443

(22) Filed: Aug. 8, 2007

(30) Foreign Application Priority Data
Aug. 18, 2006 (TW) 095130528

(51) Int. Cl. G03C 5/00

(52) U.S. Cl. 430/322

(57) ABSTRACT

The present invention relates to a method for exposing twice by two masks in a semiconductor process, which includes: (a) providing a substrate having a surface; (b) forming a negative-type photosensitive material on the surface of the substrate; (c) providing a first mask having a first pattern; (d) performing a first exposure procedure on the negative-type photosensitive material by utilizing a first light beam through the first mask; (e) providing a second mask having a second pattern, wherein the entire texture of the second pattern is substantially identical to that of the first pattern; and (f) performing a second exposure procedure on the negative-type photosensitive material by utilizing a second light beam through the second mask. Thus, the negative-type photosensitive material will not be damaged and will not cause yield loss.

### BACKGROUND OF THE INVENTION

1. Field of the Invention

The present invention relates to a method for exposing twice. More particularly, the present invention relates to a method for exposing twice by two masks in a semiconductor process.

2. Description of the Related Art

FIGS. 1 to 4 show schematic views of exposing and developing processes of a wafer in a conventional semiconductor process. Firstly, referring to FIG. 1, a wafer 10 is provided. The wafer 10 has a surface 101 and a plurality of bonding pads 11 disposed on the surface 101. Next, referring to FIG. 2, a polyimide (PI) passivation layer 12 is formed on the surface 101 of the wafer 10. The PI passivation layer 12 is of a negative-type photosensitive material.

Then, referring to FIG. 3, a mask 14 is provided. The mask 14 has a pattern 141 and a non-exposed pattern 142. The non-exposed pattern 142 corresponds to the bonding pads 11 in order to expose the bonding pads 11 in subsequent processes. Normally, the mask 14 may have extra impurities or an extra particle 143 located in the pattern 141. After that, a light beam 16 is utilized to pass through the mask 14, so as to perform an exposure procedure on the PI passivation layer 12. The light beam 16 passes through the pattern 141, so that the corresponding PI passivation layer 12 has chemical reactions, and is not removed during development. However, as the particle 143 blocks the light beam 16, a part of the area that should be irradiated by the light beam 16 originally is not irradiated by the light beam 16, and does not have chemical reactions.

Then, referring to FIG. 4, after the mask 14 is removed, a developer is used to proceed with a developing procedure on the PI passivation layer 12. The area not irradiated by the light beam 16 will be washed out by the developer, but the area irradiated by the light beam 16 will remain because of the chemical reactions thereon. Thus, only the bonding pads 11 are exposed for the subsequent processes. However, it is known from FIG. 4 that a part of the PI passivation layer 12 does not have chemical reactions as it is blocked by the particle 143, so this part will also be washed out by the developer, causing damage of the PI passivation layer 12 and unexpectedly exposing part of the surface 101 of the wafer 10, which will result in yield loss.

Therefore, it is necessary to provide a method for exposing twice in a semiconductor process to solve the above problems.

### SUMMARY OF THE INVENTION

The object of the present invention is to provide a method for exposing twice in a semiconductor process, which includes:

(a) providing a substrate having a surface;

(b) forming a negative-type photosensitive material on the surface of the substrate;

(c) providing a first mask having a first pattern;

(d) performing a first exposure procedure on the negative-type photosensitive material by utilizing a first light beam through the first mask;

(e) providing a second mask having a second pattern, in which the entire texture of the second pattern is identical to that of the first pattern; and

(f) performing a second exposure procedure on the negative-type photosensitive material by utilizing a second light beam through the second mask.

Thus, the negative-type photosensitive material will not be damaged and will not cause yield loss.

### BRIEF DESCRIPTION OF THE DRAWINGS

FIGS. 1 to 4 are schematic views of exposing and developing processes of a wafer in a conventional semiconductor process;

FIGS. 5 to 9 are schematic views of exposing and developing processes of a wafer in a semiconductor process according to the present invention;

FIGS. 10 to 12 are schematic views showing errors when exposing twice by two masks having identical patterns according to the present invention, in which the width of the first non-exposed pattern is identical to that of the second non-exposed pattern;

FIGS. 13 to 15 are schematic views showing errors when exposing twice by two masks having identical patterns according to the present invention, in which the width of the first non-exposed pattern is larger than that of the second non-exposed pattern; and

FIGS. 16 to 18 are schematic views showing errors when exposing twice by two masks having identical patterns according to the present invention, in which the width of the first non-exposed pattern is smaller than that of the second non-exposed pattern.

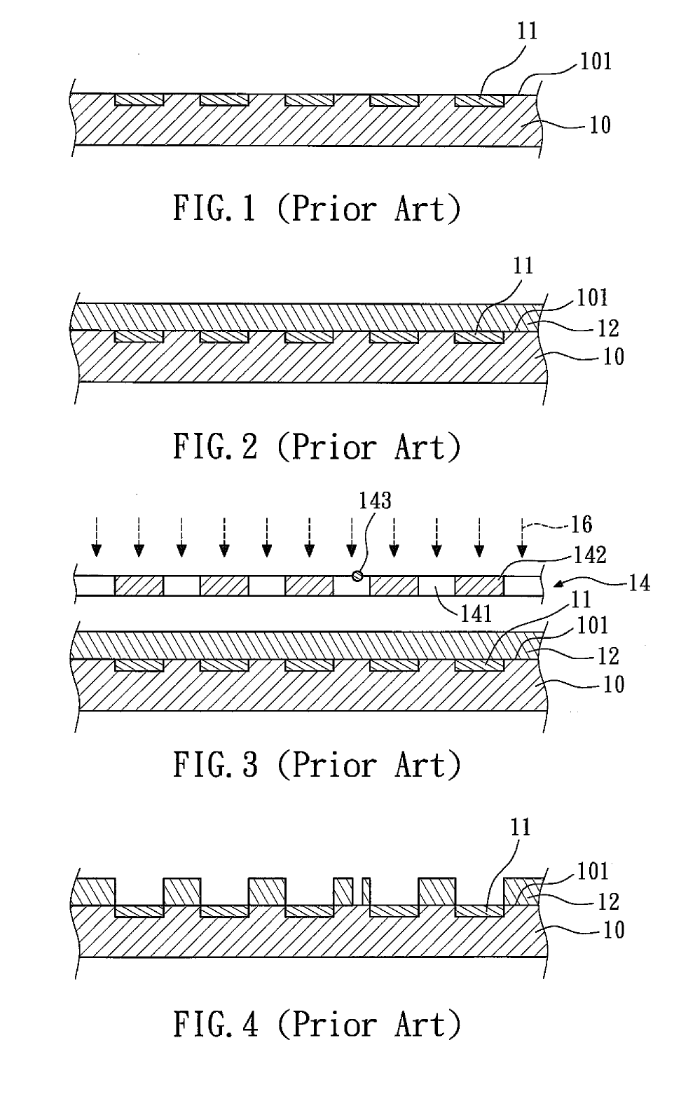

### DETAILED DESCRIPTION OF THE INVENTION

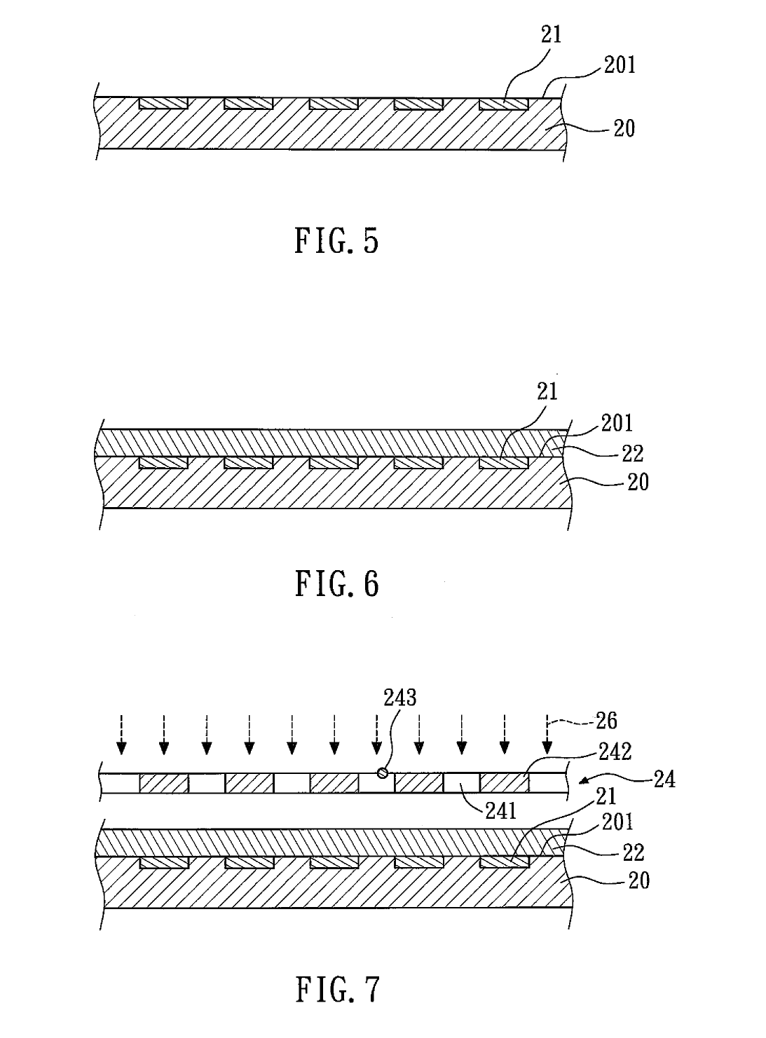

FIGS. 5 to 9 show schematic views of exposing and developing processes of a wafer in a semiconductor process according to the present invention. Firstly, referring to FIG. 5, a substrate (e.g., a wafer 20) is provided. The wafer 20 has a surface 201 and a plurality of bonding pads 21 on the surface 201. Referring to FIG. 6, a negative-type photosensitive material (e.g., polyimide, PI) passivation layer 22 is formed on the surface 201 of the wafer 20.

Referring to FIG. 7, a first mask 24 is provided. The first mask 24 has a first pattern 241 and a first non-exposed pattern 242. The first non-exposed pattern 242 corresponds to the area to be exposed (e.g., the bonding pads 21), so as to expose the area in the subsequent processes. Normally, the first mask 24 may have extra impurities or particles (e.g., a first particle 243), and the first particle 243 is located in the first pattern 241. After that, a first light beam 26 is utilized to pass through the first mask 24, so as to perform a first exposure procedure on the PI passivation layer 22. The first light beam 26 passes through the first pattern 241, so that the corresponding PI passivation layer 22 has chemical reactions, and is not removed during development. However, as the first particle 243 blocks the first light beam 26, a part of the area that should be irradiated by the first light beam 26 originally is not irradiated by the first light beam 26, and does not have chemical reactions.

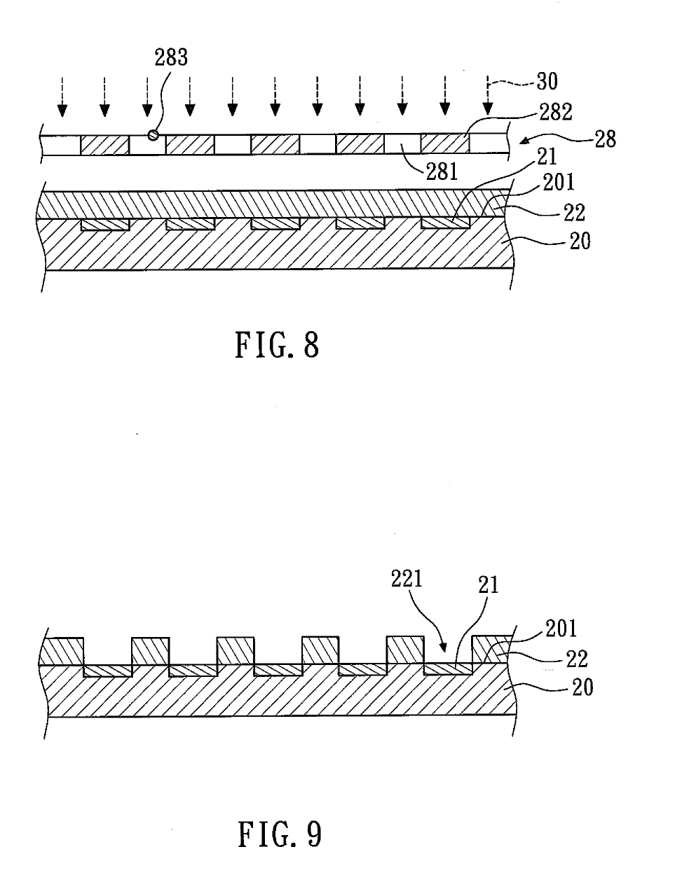

Referring to FIG. 8, a second mask 28 is provided. The second mask 28 has a second pattern 281 and a second non-exposed pattern 282. The entire texture of the second pattern 281 is identical to that of the first pattern 241. Normally, the second mask 28 may also have extra impurities or particles (e.g., a second particle 283), and the second particle 283 is located in the second pattern 281. It can be understood that it is almost impossible for the second particle 283 to be located at the same position as the first particle 243.

A second light beam 30 is utilized to pass through the second mask 24, so as to perform a second exposure procedure on the PI passivation layer 22. The second light beam 30 passes through the second pattern 281, SO that the corresponding PI passivation layer 22 has chemical reactions, and is not removed during development. During this exposure procedure, as no particle exists at the position corresponding to the first particle 243, the area of the PI passivation layer 22 blocked by the first particle 243 and not having chemical reactions on the first exposure procedure will have chemical reactions as it is irradiated by the second light beam 30 in this second exposure procedure. In addition, the area blocked by the second particle 283 has already had chemical reactions in the first exposure procedure.

Referring to FIG. 9, after the second mask 28 is removed, a developer is used to perform a developing procedure on the PI passivation layer 22. After the above two exposure procedures, the area irradiated by the first light beam 26 or the second light beam 30 remains because of the chemical reactions thereon, so as to form a plurality of openings 221 to expose the bonding pads 21 for the subsequent processes. Thus, the damage to the PI passivation layer 12 (as shown in FIG. 4) and the yield loss in the conventional art will not occur.

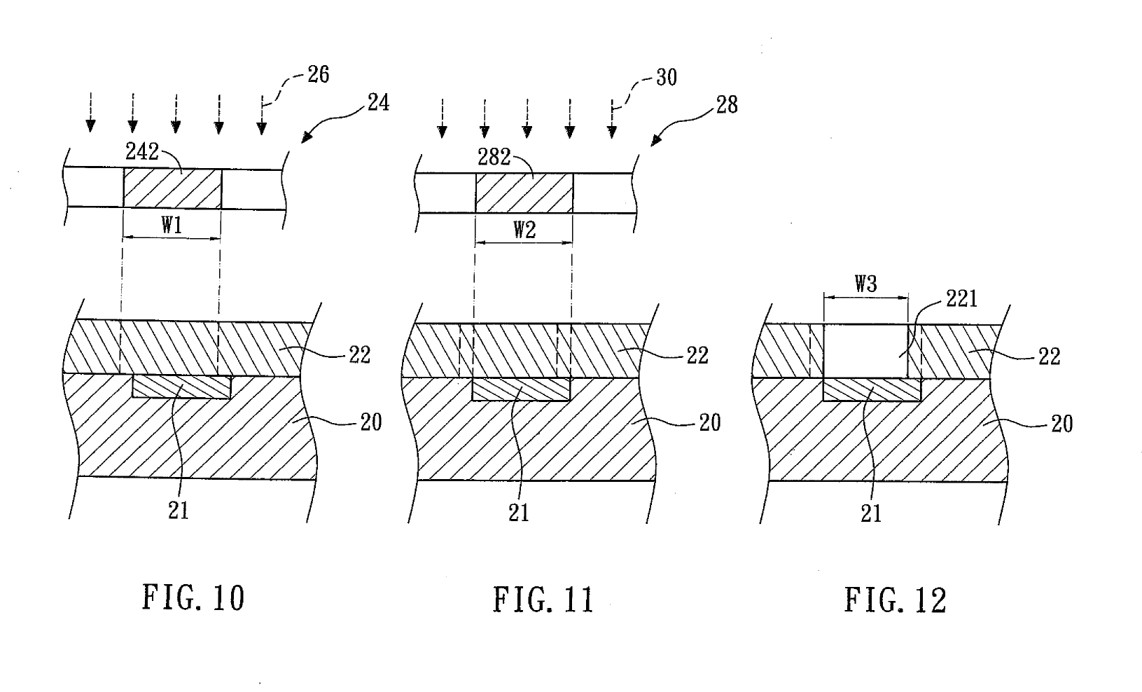

It should be noted that the present invention uses two masks having identical patterns for exposing twice, and thus when aligning them, it is possible that the openings 221 in the PI passivation layer 22 are not aligned with or have positional differences compared to the bonding pads 21 because of mechanical errors or human errors. FIGS. 10 to 12 are schematic views showing errors when exposing twice by two masks having identical patterns according to the present invention, in which the width of the first non-exposed pattern is identical to that of the second non-exposed pattern. Referring to FIG. 10, the width W₁ of the first non-exposed pattern 242 of the first mask 24 is 60 μm (identical to the horizontal width of the bonding pads 21). Then, the first light beam 26 is utilized to pass through the first mask 24 to perform the first exposure procedure on the PI passivation layer 22. After that, the first mask 24 is removed, and the second mask 28 is provided.

Referring to FIG. 11, the width W₂ of the second non-exposed pattern 282 of the second mask 28 is 60 μm. Then, the second light beam 30 is used to pass through the second mask 28 to perform the second exposure procedure on the PI passivation layer 22. The position of the s second mask 28 has a shift of 2 μm relative to the position of the first mask 24. Referring to FIG. 12, a developer is used to perform a developing procedure on the PI passivation layer 22. After the above two exposure procedures, the area irradiated by the first light beam 26 or the second light beam 30 remains, so as to form a plurality of openings 221. The width W₃ of each of the openings 221 is 58 μm, which is smaller than the horizontal width of the bonding pads 21, so the width of the openings 221 is smaller than the required width.

In order to eliminate the above disadvantages, two methods can be adopted when designing the patterns of the masks. The first method is that the width of the second non-exposed pattern 282 of the second mask 28 is the actual required width, and the width of the first non-exposed pattern 242 of the first mask 24 is designed to be larger than the width of the second non-exposed pattern 282 by 2 μm to 4 μm. The second method is that the width of the first non-exposed pattern 242 of the first mask 24 is the actual required width, and the width of the second non-exposed pattern 282 of the second mask 28 is designed to be larger than the width of the first non-exposed pattern 242 by 2 μm to 4 μm.

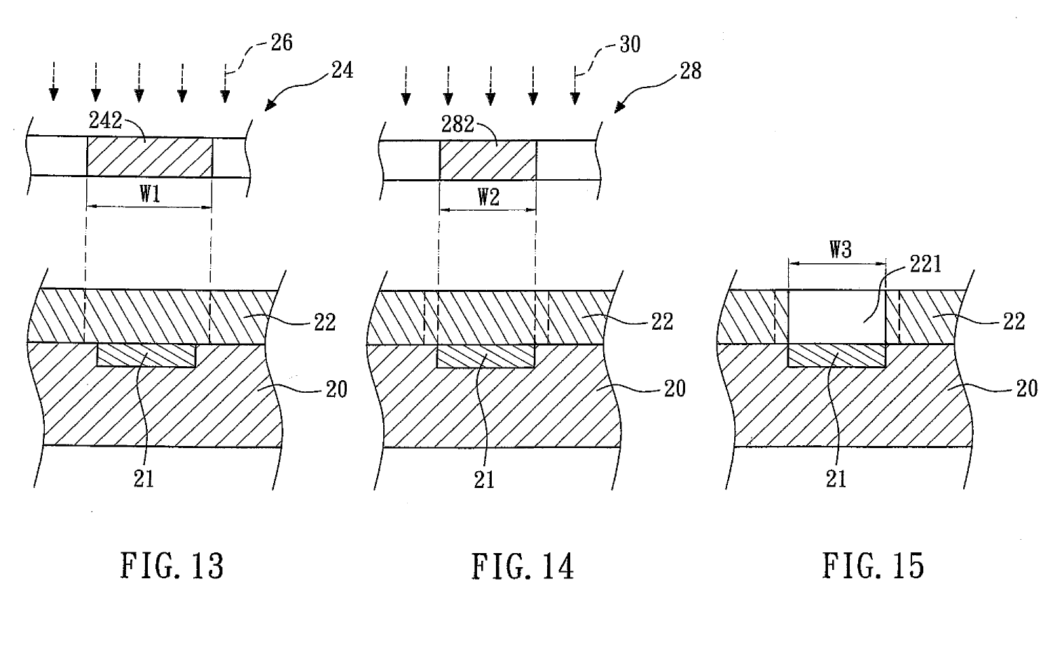

FIGS. 13 to 15 are schematic views showing errors when exposing twice by two masks having identical patterns according to the present invention, in which the width of the first non-exposed pattern is greater than that of the second non-exposed pattern, i.e., the aforementioned first method. Referring to FIG. 13, the width W₁ of the first non-exposed pattern 242 of the first mask 24 is 64 μm (larger than the horizontal width of the bonding pads 21). Then, the first light beam 26 is utilized to pass through the first mask 24 to perform the first exposure procedure on the PI passivation layer 22. After that, the first mask 24 is removed, and the second mask 28 is provided.

Referring to FIG. 14, the width W₂ of the second non-exposed pattern 282 of the second mask 28 is 60 μm. Then, the second light beam 30 is used to pass through the second mask 28 to perform the second exposure procedure on the PI passivation layer 22. The position of the second mask 28 has a shift of 2 μm with respect to the position of the first mask 24. Referring to FIG. 15, a developer is used to perform a developing procedure on the PI passivation layer 22. After the above two exposure procedures, the area irradiated by the first light beam 26 or the second light beam 30 remains, so as to form a plurality of openings 221. The width W₃ of each of the openings 221 is 60 μm, which is identical to the horizontal width of the bonding pads 21.

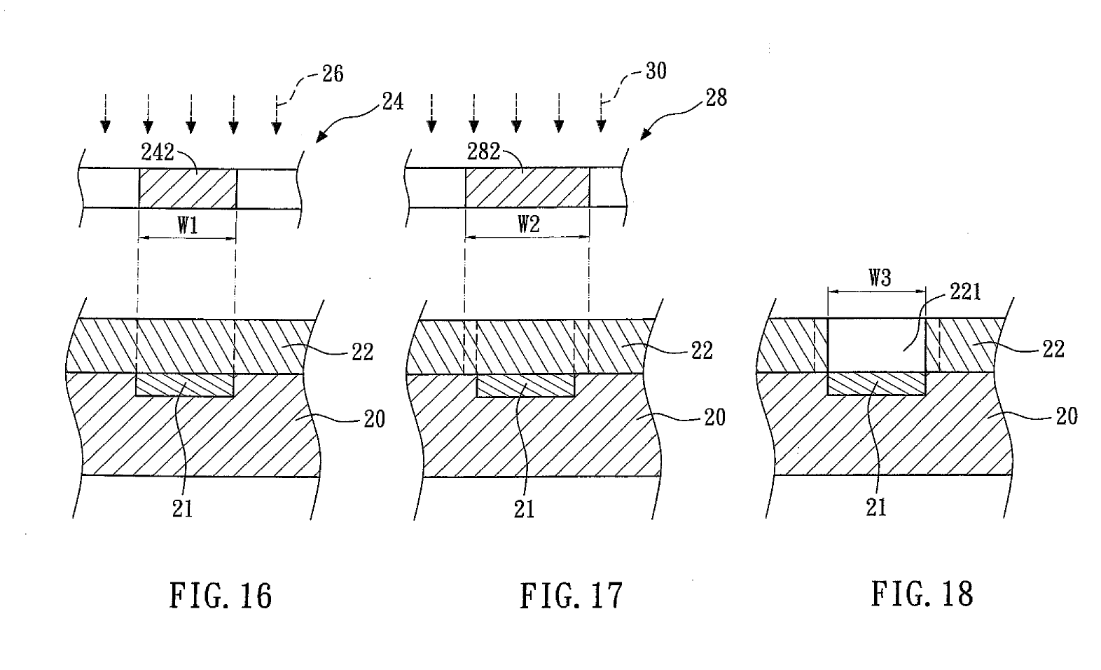

FIGS. 16 to 18 are schematic views showing errors when exposing twice by two masks having identical patterns according to the present invention, in which the width of the first non-exposed pattern is smaller than that of the second non-exposed pattern, i.e., the aforementioned second method. Referring to FIG. 16, the width W₁ of the first non-exposed pattern 242 of the first mask 24 is 60 μm (identical to the horizontal width of the bonding pads 21). Then, the first light beam 26 is utilized to pass through the first mask 24 to perform the first exposure procedure on the PI passivation layer 22. After that, the first mask 24 is removed, and the second mask 28 is provided.

Referring to FIG. 17, the width W₂ of the second non-exposed pattern 282 of the second mask 28 is 64 μm. Then, the second light beam 30 is used to pass through the second mask 28 to perform the second exposure procedure on the PI passivation layer 22. The position of the second mask 28 has a shift of 2 μm with respect to the position of the first mask 24. Referring to FIG. 18, a developer is used to perform a developing procedure on the PI passivation layer 22. After the above two exposure procedures, the area irradiated by the first light beam 26 or the second light beam 30 remains, so as to form a plurality of openings 221. The width W₃ of each of the openings 221 is 60 μm, which is identical to the horizontal width of the bonding pads 21.

While several embodiments of the present invention have been illustrated and described, various modifications and improvements can be made by those skilled in the art. The embodiments of the present invention are therefore described in an illustrative but not restrictive sense. It is intended that the present invention should not be limited to the particular forms as illustrated, and that all modifications which maintain the spirit and scope of the present invention are within the scope defined in the appended claims.

What is claimed is:

1. A method for exposing twice by two masks in a semiconductor process, comprising:
(a) providing a substrate having a surface;
(b) forming a negative-type photosensitive material on the surface of the substrate;
(c) providing a first mask having a first pattern;
(d) performing a first exposure procedure on the negative-type photosensitive material by utilizing a first light beam through the first mask;
(e) providing a second mask having a second pattern, wherein the entire texture of the second pattern is substantially identical to that of the first pattern; and
(f) performing a second exposure procedure on the negative-type photosensitive material by utilizing a second light beam through the second mask.

2. The method as claimed in claim 1, wherein the substrate is a wafer having a plurality of bonding pads.

3. The method as claimed in claim 1, wherein the negative-type photosensitive material is polyimide (PI).

4. The method as claimed in claim 1, wherein the first mask further has a first non-exposed pattern, the second mask further has a second non-exposed pattern, and a width of the first non-exposed pattern is larger than that of the second non-exposed pattern.

5. The method as claimed in claim 1, wherein the first mask further has a first non-exposed pattern, the second mask further has a second non-exposed pattern, and a width of the second non-exposed pattern is larger than that of the first non-exposed pattern.

6. The method as claimed in claim 1, further comprising a step of performing a developing procedure after the step (d).
